(19) United States
(12) Patent Application Publication
(10) Pub. No.: US 2021/0215148 A1
(43) Pub. Date: Jul. 15, 2021

(54) METHOD AND EQUIPMENT FOR IMPROVING THE EFFICIENCY OF COMPRESSORS AND REFRIGERATORS

(71) Applicant: Aurelio Mayorca, Santa Catarina (BR)

(72) Inventor: Aurelio Mayorca, Santa Catarina (BR)

(21) Appl. No.: 17/217,921

(22) Filed: Mar. 30, 2021

Related U.S. Application Data
(63) Continuation of application No. 15/174,573, filed on Jun. 6, 2016, now Pat. No. 10,961,995.
Application No. 15/174,573 is a continuation-in-part of application No. 13/143,869, filed on Sep. 28, 2011, now abandoned.

(30) Foreign Application Priority Data
Jan. 9, 2009 (BR) PI 0903956-2

(51) Int. Cl. F04B 39/12; F04B 25/00; F04B 27/00; F04B 27/02; F04B 27/04; F04B 35/04; F04B 39/00

(52) U.S. Cl. CPC F04B 39/121; F04B 39/123; F04B 25/005; F04B 27/005; F04B 27/02; F04B 27/04; F05C 2201/0475; F04B 27/0409; F04B 35/04; F04B 39/0022; F04B 39/0094; F04B 39/122; F04B 39/125; F04B 27/0404

(57) ABSTRACT

A hermetic compressor may include a crankshaft having an input shaft rotatably supported on the cast-iron block along the crankshaft axis and connected to the electric motor rotary output, and an eccentric crankpin orbitally rotating about the axis as the crankshaft is rotated. A pair of opposed pistons may lie on the common plane. Each piston may be pivotably connected to one of the connecting rod piston ends to drive the pistons in an oscillatory manner within the cylinders as the crankshaft rotates. The piston and cylinder pairs may cause fluid to be pumped from the inlet port to the outlet port as the piston oscillates varying the volume of the enclosed space bound by the piston and the cylinder pairs.

### CROSS-REFERENCE TO RELATED APPLICATIONS

This application is a continuation of U.S. application Ser. No. 15/174,573, filed on Jun. 6, 2016, now U.S. Pat. No. 10,961,995, which was a continuation-in-part of U.S. application Ser. No. 13/143,869 filed on Sep. 28, 2011, which is the U.S. national phase of PCT Appln. No. PCT/BR2010/000008 filed Jan. 8, 2010 which claims priority to Brazilian application PI 0903956-2 filed Jan. 9, 2009, the disclosures of each of which are hereby incorporated in their entirety by reference.

### TECHNICAL FIELD

The embodiments described herein relate to an apparatus and method for converting rotational motion into linear motion and evacuating non-compressible gases of a compressor.

### BACKGROUND

A general hermetic compressor includes a motor portion and compressor portion sealed in a hermetic container. A compressor may be classified as reciprocating, rotary, or any other type where a refrigerant is compressed. In general, a hermetic compressor has a crank shaft coupled to a rotor of the motor part that transfers power to reciprocating pistons. The reciprocating pistons compress the compressible gas within a cylinder. Reciprocating pistons may be arranged in offset horizontal planes that cause unwanted forces on the crankpin and crankshaft. In order to compensate for the unwanted forces, larger crankshaft bearings may be required.

A lower part of the hermetic container may be filled with oil or a condensed fluid. An oil path is formed in an axial direction of the crank shaft, and an oil feeder is installed at a lower end of the oil path so as to be immersed in oil. As the crank shaft rotates, oil is pumped along the oil path to be fed, supplying the required components with lubrication. The hermetic container may be filled at the factory to properly seal the container. A factory fill may require additional transportation and installation costs.

### SUMMARY

A hermetic compressor may include a hermetic shell having a shell and a base which collectively define an enclosed cavity. The hermetic shell may define a discharge port and a suction port. The hermitic compressor may include an electric motor having a stator disposed within the enclosed cavity on the base. The motor may have a rotary output. The compressor may be made of a cast-iron block and include a head assembly. The cast-iron block and head assembly may define a crankshaft axis. The cast-iron block may include a pair of directly opposed cylinders oriented perpendicular to the crankshaft axis, each having an inlet and an outlet port.

The compressor may include a crankshaft having an input shaft rotatably supported on the cast-iron block along the crankshaft axis and connected to the electric motor rotary output, and an eccentric crankpin orbitally rotating about the axis as the crankshaft is rotated. A pair of opposed pistons may lie on the common plane. Each piston may be pivotably connected to one of the connecting rod piston ends to drive the pistons in an oscillatory manner within the cylinders as the crankshaft rotates. The piston and cylinder pairs may cause fluid to be pumped from the inlet port to the outlet port as the piston oscillates varying the volume of the enclosed space bound by the piston and the cylinder pairs.

A pair of connecting rods may have a crankshaft end with a bearing opening surrounding the eccentric crankpin, a spaced apart piston end and a rod portion there between. The connecting rods may generally lie in a common plane perpendicular to the input shaft axis with each of the first ends axially offset from one another in a dogleg manner lying on opposite side of the common plane to surround the crankpin.

The connecting rod assembly may include a friction reduction element disposed between the connecting rod crankshaft ends and a plurality of spring feet mounted on the hermetic shell base in spaced apart relation for supporting the compressor on a support surface.

A pipe may connect the outlet port of a first cylinder to the inlet port of the other second cylinder in a serial fashion with the first cylinder inlet port coupled to the hermetic shell and the second cylinder outlet port discharging to the discharge port exiting the hermetic shell. In at least one other embodiment, a pair of outlet pipes connect the pair of outlet ports to the discharge port exiting the hermetic shell.

### BRIEF DESCRIPTION OF THE DRAWINGS

FIG. 1 is an isometric external view of the compressor used for refrigeration;

FIG. 2 is a sectional view of a dual cylinder hermetic refrigerant compressor without the hermetic compressor;

FIG. 3 is a top view of the compressor having a crankshaft and eccentric crankpin;

FIG. 4 is an isometric view of the compressor having serial discharge;

FIG. 5 is a top view of the compressor having serial discharge;

FIG. 6 is a view of the compressor having parallel discharge;

FIG. 7 is a view of the compressor having spring feet;

FIG. 8 is a side vertical view of the eccentric and the two bearings; and

FIG. 9 is a top sectional view of the eccentric and the two bearings.

### DETAILED DESCRIPTION

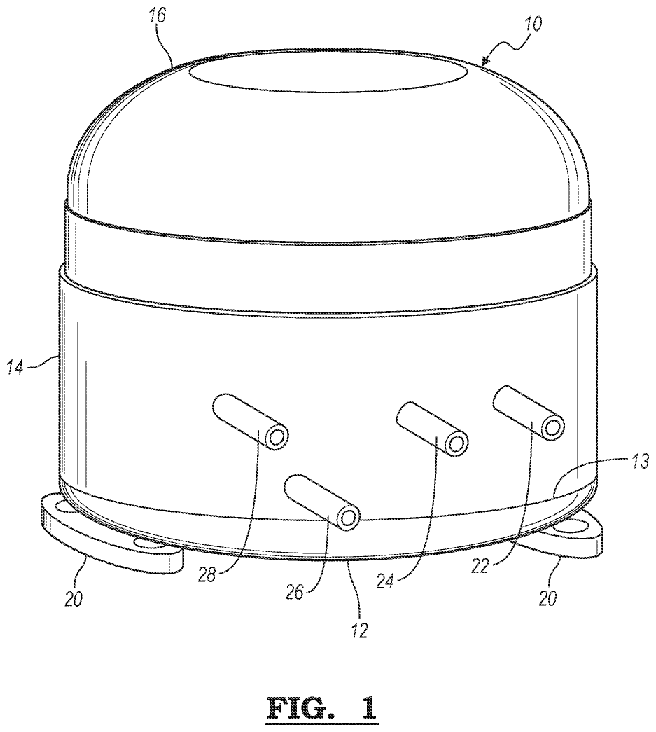

Referring to FIG. 1, a hermetically sealed compressor includes a hermetic shell 10 including a refill port 28, discharge port 24, suction port 22, and vent port 26. The hermetic shell 10 has a base 12, a body 14, and a top 16. The hermetic shell 10 contains an oil that fills the base 12 to a level near the seam 13 of the base 12 and body 14. The hermetic shell 10 has a vent port 26 disposed near the maximum level of the oil to release undesired, uncompressible accumulated gases.

The preferred embodiment improves on previous methods to evacuate trapped gases that are undesirable. Prior to the preferred embodiment, these trapped gases were evacuated at the site of manufacture by vacuum suction. The preferred embodiment includes a vent port 26 to release trapped air at the installation site. The vent port 26 is disposed above the seam 13 to prevent oil leakage during gas evacuation.

The vent port 26 provides an effective way to remove trapped gases that are undesirable at the installation site. The method for removing undesirable gases primarily uses the vent port 26 and the refill port 28. Initially, the vent port 26 is closed. Trapped moisture is then removed from the system by drawing a vacuum on the refill port 28. The hermetic shell 10 is then pressurized using the refill port 28 and refrigerant or inert gas. The internal pressure of the hermetic shell may be raised to any level sufficient to promote the release of undesirable gases. Typically, the hermetic shell 10 pressure is raised more than one quarter of the normal working pressure, but less than the full normal working pressure of the compressor.

The heavier air is then allowed to settle to the bottom of the hermetic shell, but above the level of the resting oil, which is generally located at the seam 13. The opening of the vent port 26 then releases undesirable gases from the hermetic shell, which leaves only oil and refrigerant gas retained in the shell.

An important requirement prior to the use of the hermetic compressor system is to ensure the proper amount of refrigerant is present in the system prior to use. Verification of adequate refrigerant may be performed numerous ways, but the following are example methods used to verify adequate refrigerant in the system.

The preferred method to ensure the compressor is adequately filled with refrigerant is to measure the weight and volume of the amount of air removed from the system through the vent port 26. This method is well known to those skilled in the art. The installer would then add refrigerant as necessary.

The second method to ensure the proper amount of refrigerant is to measure the internal pressure of the hermetic shell 10 and adjust the amount of refrigerant as necessary. This method is well known to those skilled in the art. The new process for high-efficiency cooling, described as putting gas in the sealed refrigeration systems free from any contamination, caters to all types of gas (e.g. R134 or R600).

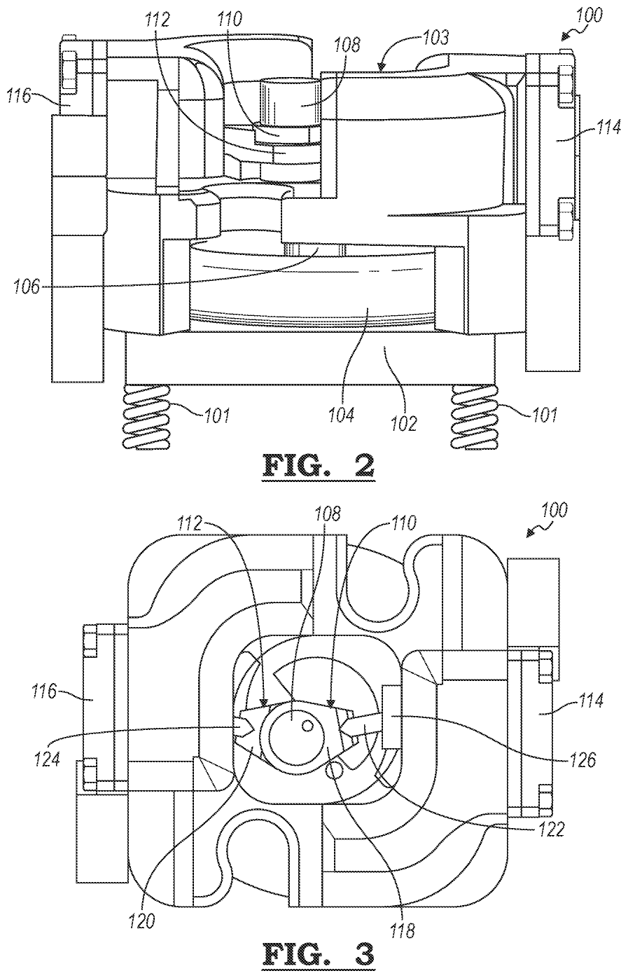

Now referring to FIGS. 2 and 3, the motor-compressor 100 has a cast-iron block 103 mounted within the hermetic shell. The motor-compressor 100 has a motor having a stator 102 and end windings 104. The motor-compressor 100 may be mounted on spring feet 101 to lift the stator 102 of the motor from the base 12 of the hermetic shell 10. The motor-compressor 100 may have a stator 102 including end turns or end windings 104 to generate a magnetic field, which generate torque on a rotor (not shown). The rotor may be attached to the crankshaft 106. The crankshaft may be attached to a crankpin 108. The crankshaft 106 and crankpin 108 may be a unitary piece. The crankshaft 106 may extend concentrically from the center axis of the stator 102 and motor compressor 100. The crankshaft 106 has an eccentric crankpin 108 that orbits about the crankshaft 106. L-shaped connecting rods 110, 112 are disposed on the eccentric crankpin 108. The L-shaped connecting rods 110, 112 have a dogleg profile. The motor-compressor has a set of compression chamber heads 114, 116. Each of connecting rods 110, 112 include a bearing at the crankpin end or crankpin end portion 118, 120 to provide free rotation about the crankpin 108. Each of the connecting rods 110, 112 include a detachable piston end or piston end portion 122, 124 that connects to respective pistons 126, 128 (piston 128 not shown).

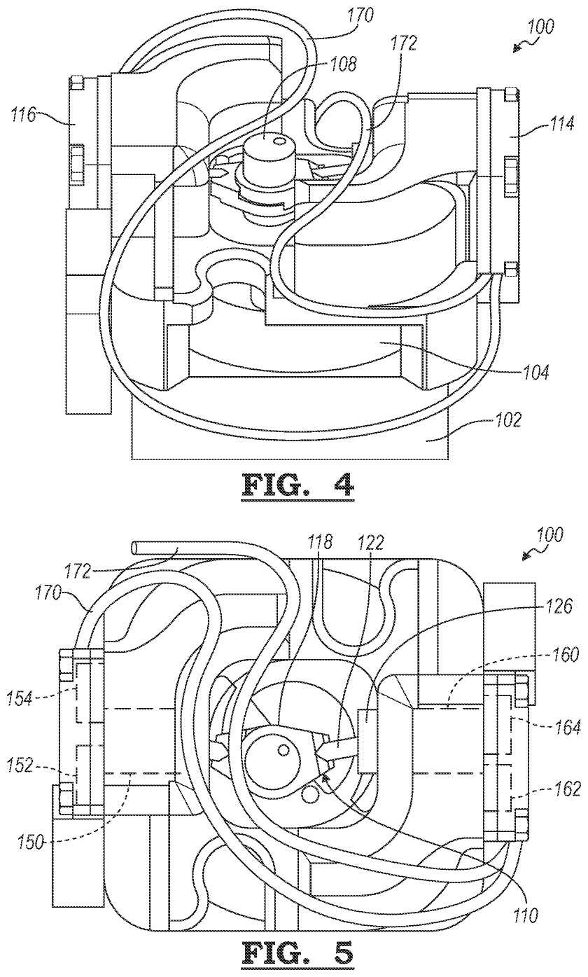

Now referring to FIGS. 4 and 5, an exemplary embodiment of serial discharge is shown. The first cylinder 150 has a first inlet port 152 that receives suction from the volume inside the hermetic shell or the suction port 22. The first cylinder 150 has a first outlet port 154 that is routed via piping 170 to the second inlet port 162 of the second cylinder 160. The second outlet port 164 of the second cylinder 160 is routed near the chamber head 116 and is further routed via piping 172 to the compressor discharge port 24 as shown in FIG. 1. This provides increased compression and reduced volume of the refrigerant gas.

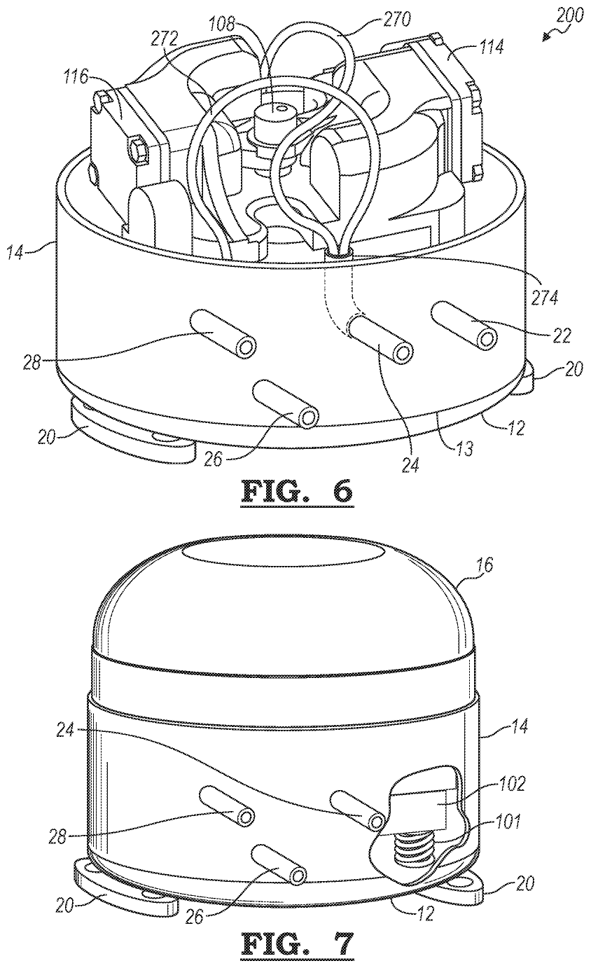

Now referring to FIG. 6, in at least one other embodiment a parallel discharge configuration 200 is shown. A pair of outlet pipes 270, 272 connect the pair of outlet ports (as shown in FIG. 5) of the cylinders to the discharge port exiting the hermetic shell. The first and second cylinders have respective outlet pipes 270, 272. The discharges are fed to a common manifold 274, which leads to the discharge port 24. The compressor has similar features to the series configuration of FIGS. 4 and 5. As shown, the compressor has an suction port 22, vent port 26, and refill port 28. The hermetic shell has a base 12, seam 13, and body 14. Each compression chamber head 114, 116 contains a cylinder (not shown). The compressor has an eccentric crankpin 108 that is free-standing on one end.

Now referring to FIG. 7, the compressor is shown being situated on spring feet 101, which are attached and support the stator 102. The spring feet 101 separate the base 12 and the stator 102. The spring feet 101 are fitted onto brackets welded to the inner wall of the airtight body. The compressor may include four spring feet 101 that are mounted to form a rectangle. The compressor has separate mounting feet 20 for mounting and stabilization.

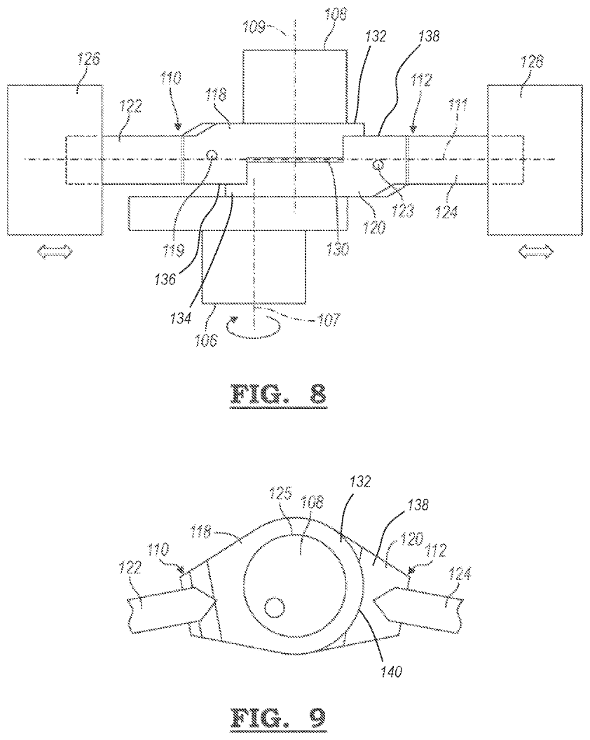

Now referring to FIGS. 8 and 9, the L-shaped connecting rod 110 defines a hole 119 on the crankpin end 118 of the connecting rod 110. The hole 119 may be used to connect the crankpin end 118 and piston end 122. The crankpin end 118 of the connecting rod 110 is rotationally attached to the crankpin 108 with a bearing sized to receive the crankpin 108. The crankpin end 118 can then orbit about the crankshaft 106, which has a crankshaft axis 107, along with the crankpin 108. The orbiting motion of the crankpin end 118 causes the attached piston end 122 to reciprocate. The reciprocating motion of the piston end 122 causes the piston 126 to similarly reciprocate. The reciprocating motion of the piston 126 compresses the compressible gas of the cylinder.

The L-shaped connecting rod 110 as described above has a symmetric companion L-shaped connecting rod 112. The companion L-shaped connecting rod 112 defines a hole 123 on crankpin end 120 of the connecting rod 112. The hole 123 may be used for a pin to connect the crankpin end 120 and piston end 124. The crankpin end 120 of the connecting rod 112 is rotationally attached to the crankpin 108 with a bearing sized to receive the crankpin 108. The crankpin end 120 can then orbit about the crankshaft 106 along with the crankpin 108. The orbiting motion of the crankpin end 120 causes the attached piston end 124 to reciprocate. The reciprocating motion of the piston end 124 causes the piston 128 to similarly reciprocate. The reciprocating motion of the piston 126 compresses the compressible gas of the cylinder.

The companion L-shaped connecting rod 112 is flipped about a horizontal plane 111, which is perpendicular to the eccentric axis or crankpin axis 109, such that the piston ends 122, 124 of both connecting rods 110, 112 are aligned along a common horizontal plane 111. The piston end 124 of the companion L-shaped connecting rod 112 is oriented in the opposite direction of the piston end 122 of the L-shaped connecting rod 110. Further, the connecting rods 110, 112 interleave with each other. Specifically, crankpin end 118 of connecting rod 110 has a semicircular portion 132 opposite the crankpin 108 from the side of crankpin end 118 that joins to the piston end 122. Similarly, crankpin end 120 of connecting rod 112 has a semicircular portion 134 opposite the crankpin 108 from the side of crankpin end 120 that joins to piston end 124. Semicircular portion 132 of crankpin end 118 lies entirely on one side of the horizontal plane 111, and semicircular portion 134 of crankpin end 120 lies entirely on the opposite side of horizontal plane 111 from semicircular portion 132. The side of crankpin end 120 that connects to piston end 124 has a portion 138 that extends across the horizontal plane 111, and has an arcuate recess 140 in which semicircular portion 132 of crankpin end 118 partially sits. Likewise, crankpin end 118, at the end of crankpin end 118 that connects to piston end 122, has a portion 136 that extends across the horizontal plane 111, in which semicircular portion 134 of crankpin end 120 partially sits in a similar arcuate recess. Further, both piston end 122 of connecting rod 110 and piston end 124 of connecting rod 112 each have a longitudinal axis, from their respective crankpin end 118, 120 to their respective pistons 126, 128 that is entirely on the horizontal plane 111.

The orientation of the companion L-shaped connecting rod 112 to the L-shaped connecting rod 110 is one of the novel aspects of the embodiment because the piston ends 122, 124 of the connecting rods 110, 112 operate on the same horizontal plane 111. This provides enhanced symmetry for the compressor because each of the pistons 126, 128 are disposed on the same plane and create opposing forces. This configuration allows reciprocating movement of the pistons 126, 128 in the same plane without undesirable stresses.

Conflicting rotation of the connecting rods 110, 112 may cause unwanted friction and restricted movement. A thin washer 130 may be disposed between the L-shaped connecting rods 110, 112 may have a thickness between 0.1 mm and 0.3 mm. The washer may relieve mechanical friction, which tends to create counter force to the rotation of the bearing with respect to each other.

The connecting rods 110, 112 form a tear shape truncated toward the piston ends 122, 124. Each of the connecting rods 110, 112 define a bearing opening 125, 127 on respective connecting rod crankpin ends 118, 120. The connecting rod crankpin ends 118, 120 also define a cleft for receiving the piston ends 122, 124 of the connecting rods 110, 112. The pistons 126, 128 are connected on the distal end of the connecting rod piston ends 122, 124. The compressor pistons 126, 128 reciprocate within the cylinders (not shown).

What is claimed is:

1. A hermetic compressor comprising:
a hermetic shell having a shell and a base which collectively define an enclosed cavity, with a discharge port, and suction port defining in the hermetic shell;
an electric motor having a stator disposed within the enclosed cavity on the base, the motor having a rotary output;
a compressor having:
a cast-iron block and head assembly having a crankshaft axis, and a pair of directly opposed cylinders oriented perpendicular to the crankshaft axis, each having an inlet and an outlet port;
a crankshaft having an input shaft rotatably supported on the cast-iron block along the crankshaft axis and connected to an electric motor rotary output, and an eccentric crankpin orbitally rotating about the axis as the crankshaft is rotated;
a pair of connecting rods each having a crankshaft end with a bearing opening surrounding the eccentric crankpin, a spaced apart piston end and a rod portion there between, wherein the connecting rods generally lie in a common plane perpendicular to an input shaft axis with each of the crankshaft ends axially offset from one another in a dogleg manner lying on opposite side of the common plane to surround the crankpin;
a friction reduction element disposed between the connecting rod crankshaft ends; and
a pair of opposed pistons lying on the common plane, each piston pivotably connected to one of the connecting rod piston ends to drive the pistons in an oscillatory manner within the cylinders as the crankshaft rotates, wherein piston and cylinder pairs cause fluid to be pumped from the inlet port to the outlet port as the piston oscillates varying a volume of an enclosed space bound by the piston and the cylinder pairs; and
a plurality of spring feet mounted on the hermetic shell base in spaced apart relation supporting the electric motor and the cast-iron block and head assembly.

2. The compressor of claim 1, wherein a pipe connects the outlet port of a first cylinder to the inlet port of the other second cylinder in a serial fashion with the first cylinder inlet port coupled to the hermetic shell and a second cylinder outlet port discharging to the discharge port exiting the hermetic shell.

3. The compressor of claim 1, wherein a pair of outlet pipes connect the pair of outlet ports to the discharge port exiting the hermetic shell.

4. The compressor of claim 1, wherein each of the pair of connecting rods is comprised of crankshaft end portion and piston end portion that are joined with a pin.
